(19) United States
(12) Patent Application Publication
(10) Pub. No.: US 2026/0270857 A1
(43) Pub. Date: Sep. 10, 2026

(54) POSITIONING ANCHOR SELECTION BASED ON REINFORCEMENT LEARNING

(71) Applicant: NOKIA SOLUTIONS AND NETWORKS OY, Espoo (FI)

(72) Inventors: Taylan SAHIN, Munich (DE); Athul PRASAD, Naperville, IL (US); Mikko SÄILY, Laukkoski (FI); Dick CARRILLO MELGAREJO, Lappeenranta (FI); Anil KIRMAZ, Munich (DE); Afef FEKI, Sceaux (FR)

(73) Assignee: 11, (omitted)

(21) Appl. No.: 19/101,142

(22) PCT Filed: Aug. 11, 2022
(86) PCT No.: PCT/EP2022/072518

§ 371 Date: Feb. 4, 2025

(51) Int. Cl. H04W 48/20; H04L 41/16; H04W 64/00

(52) U.S. Cl. CPC H04W 48/20; H04L 41/16; H04W 64/00

(57) ABSTRACT

There is provided a method, apparatus and computer program for causing a second apparatus to: signalling, to a first apparatus comprising a reinforcement learning agent, a request to select or deselect an anchor for determining a location of the first and/or second apparatus, the request comprising an indication of at least one potential anchor; receiving, from the first apparatus, a request for information related to at least one of: a resource availability of the at least one potential anchor, an energy state of the at least one potential anchor, or an indication of whether the at least one potential anchor is synchronised to a network; and providing the requested information to the first apparatus.

### FIELD OF THE DISCLOSURE

The examples described herein generally relate to apparatus, methods, and computer programs, and more particularly (but not exclusively) to apparatus, methods and computer programs for positioning anchor selection.

### BACKGROUND

A communication system can be seen as a facility that enables communication sessions between two or more entities such as communication devices, base stations and/or other nodes by providing carriers between the various entities involved in the communications path.

The communication system may be a wireless communication system. Examples of wireless systems comprise public land mobile networks (PLMN) operating based on radio standards such as those provided by 3GPP, satellite based communication systems and different wireless local networks, for example wireless local area networks (WLAN). The wireless systems can typically be divided into cells, and are therefore often referred to as cellular systems.

The communication system and associated devices typically operate in accordance with a given standard or specification which sets out what the various entities associated with the system are permitted to do and how that should be achieved. Communication protocols and/or parameters which shall be used for the connection are also typically defined. Examples of standard are the so-called 5G standards.

### SUMMARY

According to a first aspect, there is provided a method for a reinforcement learning agent located at a first apparatus, the method comprising: receiving, from a second apparatus, a request to select and/or deselect an anchor for determining a location of the first and/or second apparatus, the request comprising an indication of at least one potential anchor; requesting, from a radio access network apparatus and/or the second apparatus, and/or the at least one potential anchor, first information related to at least one of: a resource availability of the at least one potential anchor, an energy state of the at least one potential anchor, or an indication of whether the at least one potential anchor is synchronised to a network; receiving the requested first information; evaluating selecting and/or deselecting the anchor using the requested information; and signalling the evaluation to the second apparatus.

The evaluating the anchor using the requested information may comprise: constructing a state representation of an environment surrounding the apparatus whose location is to be determined; inputting the state representation into a reinforcement learning model configured to output an evaluation of whether the anchor is to be selected and/or deselected given a set of environmental parameters as an input; and outputting the evaluation.

The reinforcement learning model may be trained prior to said inputting, wherein training the reinforcement learning model may comprise at least one of: calculating a positioning accuracy and/or latency of a position determined using an anchor selected and/or deselected by the reinforcement learning model to form a first positioning accuracy and/or latency; or receiving, from the second apparatus, a second calculated positioning accuracy and/or latency of a position determined using an anchor selected and/or deselected by the reinforcement learning model.

The method may comprise: using the first and/or second calculated positioning accuracy and/or latency to form a reward signal; inputting the reward signal into the reinforcement learning model; and determining whether to modify the reinforcement learning model in dependence on the reward signal.

The method may comprise: receiving, from a third apparatus, a third calculated positioning accuracy and/or latency of a position determined using an anchor selected by the reinforcement learning model; and using the third calculated positioning accuracy and/or latency to form the reward signal.

Evaluating the anchor may comprise evaluating a suitability of the at least one potential anchor for being selected and/or deselected.

The method may comprise: requesting, from a radio access network apparatus and/or the second apparatus, and/or the at least one potential anchor, second information related to at least one of: a velocity of the at least one potential anchor; a coarse displacement from the first apparatus to the at least one potential anchor; a confidence level associated with a positioning of the at least one potential anchor; or an indication of at least one positioning capability of the at least one potential anchor; and using said second information when selecting or deselecting the anchor.

The method may comprise: requesting, from a radio access network apparatus and/or the second apparatus, and/or the at least one potential anchor, third information related to at least one of: an indication of a type of anchor of the at least one potential anchor; a channel impulse response associated with a channel of the at least one potential anchor that is used for performing positioning-related measurements; an indication of whether a channel of the at least one potential anchor that is used for performing positioning-related measurements is line-of-sight; an indication of, at the apparatus whose location is to be determined, a received power of at least one signal transmitted by the at least one potential anchor; an indication of, at the apparatus whose location is to be determined, an interference level of at least one signal transmitted by the at least one potential anchor; or an indication of a velocity of the apparatus whose location is to be determined; and using said second information when selecting the anchor.

Evaluating the anchor may comprise evaluating the anchor for the second apparatus and a third apparatus.

The evaluation may comprise at least one of: a probability distribution to be used for selecting and/or deselecting the anchor for use when performing positioning measurements; that the evaluated anchor is to be selected; that the evaluated anchor is to be deselected; a weight, priority, or rank to be used for selecting and/or deselecting the anchor for use when performing positioning measurements.

The first apparatus may be a user equipment, and the second apparatus may be a location management function.

The first apparatus may be a location management function, and the second apparatus may be a user equipment.

The first apparatus may be a first user equipment and the second apparatus may be a second user equipment.

The method may comprise: signalling, from the first apparatus to the second apparatus, an indication that at least one of said potential anchors of the received message is the selected or deselected anchor.

The method may comprise: signalling, from the first apparatus to the second apparatus, an indication that at least one of said potential anchors of the received message is not the selected or deselected anchor.

According to a second aspect, there is provided a method for a second apparatus, the method comprising: signalling, to a first apparatus comprising a reinforcement learning agent, a request to select or deselect an anchor for determining a location of the first and/or second apparatus, the request comprising an indication of at least one potential anchor; receiving, from the first apparatus, a request for information related to at least one of: a resource availability of the at least one potential anchor, an energy state of the at least one potential anchor, or an indication of whether the at least one potential anchor is synchronised to a network; and providing the requested information to the first apparatus.

The method may comprise: receiving, from the first apparatus, a request for second information related to at least one of a velocity of the at least one potential anchor; a coarse displacement from the first apparatus to the at least one potential anchor; a confidence level associated with a positioning of the at least one potential anchor; or an indication of at least one positioning capability of the at least one potential anchor; and signalling said second information to the first apparatus.

The method may comprise: receiving, from the first apparatus, a request for third information related to at least one of: an indication of a type of anchor of the at least one potential anchor; a channel impulse response associated with a channel of the at least one potential anchor that is used for performing positioning-related measurements; an indication of whether a channel of the at least one potential anchor that is used for performing positioning-related measurements is line-of-sight; an indication of, at the apparatus whose location is to be determined, a received power of at least one signal transmitted by the at least one potential anchor; an indication of, at the apparatus whose location is to be determined, an interference level of at least one signal transmitted by the at least one potential anchor; or an indication of a velocity of the apparatus whose location is to be determined; and signalling said third information to the first apparatus.

The method may comprise: receiving, from the first apparatus, an evaluation of the anchor for use in determining whether to use the anchor for performing positioning measurements, wherein the evaluation comprises at least one of: a probability distribution to be used for selecting and/or deselecting the anchor for use when performing positioning measurements; that the evaluated anchor is to be selected; that the evaluated anchor is to be deselected; a weight, priority, or rank to be used for selecting and/or deselecting the anchor for use when performing positioning measurements.

The first apparatus may be a user equipment, and the second apparatus may be a location management function.

The first apparatus may be a location management function, and the second apparatus may be a user equipment.

The first apparatus may be a first user equipment and the second apparatus may be a second user equipment.

The method may comprise: signalling, from the first apparatus to the second apparatus, an indication that at least one of said potential anchors of the received message is the selected or deselected anchor.

The method may comprise: signalling, from the first apparatus to the second apparatus, an indication that at least one of said potential anchors of the received message is not the selected or deselected anchor.

According to a third aspect, there is provided an apparatus for a reinforcement learning agent located at a first apparatus, the apparatus comprising means for: receiving, from a second apparatus, a request to select and/or deselect an anchor for determining a location of the first and/or second apparatus, the request comprising an indication of at least one potential anchor; requesting, from a radio access network apparatus and/or the second apparatus, and/or the at least one potential anchor, first information related to at least one of: a resource availability of the at least one potential anchor, an energy state of the at least one potential anchor, or an indication of whether the at least one potential anchor is synchronised to a network; receiving the requested first information; evaluating selecting and/or deselecting the anchor using the requested information; and signalling the evaluation to the second apparatus.

The means for evaluating the anchor using the requested information may comprise means for: constructing a state representation of an environment surrounding the apparatus whose location is to be determined; inputting the state representation into a reinforcement learning model configured to output an evaluation of whether the anchor is to be selected and/or deselected given a set of environmental parameters as an input; and outputting the evaluation.

The reinforcement learning model may be trained prior to said inputting, wherein training the reinforcement learning model may comprise means for performing at least one of: calculating a positioning accuracy and/or latency of a position determined using an anchor selected and/or deselected by the reinforcement learning model to form a first positioning accuracy and/or latency; or receiving, from the second apparatus, a second calculated positioning accuracy and/or latency of a position determined using an anchor selected and/or deselected by the reinforcement learning model.

The apparatus may comprise means for: using the first and/or second calculated positioning accuracy and/or latency to form a reward signal; inputting the reward signal into the reinforcement learning model; and determining whether to modify the reinforcement learning model in dependence on the reward signal.

The apparatus may comprise means for: receiving, from a third apparatus, a third calculated positioning accuracy and/or latency of a position determined using an anchor selected by the reinforcement learning model; and using the third calculated positioning accuracy and/or latency to form the reward signal.

The means for evaluating the anchor may comprise means for evaluating a suitability of the at least one potential anchor for being selected and/or deselected.

The apparatus may comprise means for: requesting, from a radio access network apparatus and/or the second apparatus, and/or the at least one potential anchor, second information related to at least one of: a velocity of the at least one potential anchor; a coarse displacement from the first apparatus to the at least one potential anchor; a confidence level associated with a positioning of the at least one potential anchor; or an indication of at least one positioning capability of the at least one potential anchor; and using said second information when selecting or deselecting the anchor.

The apparatus may comprise means for: requesting, from a radio access network apparatus and/or the second apparatus, and/or the at least one potential anchor, third information related to at least one of: an indication of a type of anchor of the at least one potential anchor; a channel impulse response associated with a channel of the at least one potential anchor that is used for performing positioning-related measurements; an indication of whether a channel of the at least one potential anchor that is used for performing positioning-related measurements is line-of-sight; an indication of, at the apparatus whose location is to be determined, a received power of at least one signal transmitted by the at least one potential anchor; an indication of, at the apparatus whose location is to be determined, an interference level of at least one signal transmitted by the at least one potential anchor; or an indication of a velocity of the apparatus whose location is to be determined; and using said second information when selecting the anchor.

The means for evaluating the anchor may comprise means for evaluating the anchor for the second apparatus and a third apparatus.

The evaluation may comprise at least one of: a probability distribution to be used for selecting and/or deselecting the anchor for use when performing positioning measurements; that the evaluated anchor is to be selected; that the evaluated anchor is to be deselected; a weight, priority, or rank to be used for selecting and/or deselecting the anchor for use when performing positioning measurements.

The first apparatus may be a user equipment, and the second apparatus may be a location management function.

The first apparatus may be a location management function, and the second apparatus may be a user equipment.

The first apparatus may be a first user equipment and the second apparatus may be a second user equipment.

The apparatus may comprise means for: signalling, from the first apparatus to the second apparatus, an indication that at least one of said potential anchors of the received message is the selected or deselected anchor.

The apparatus may comprise means for: signalling, from the first apparatus to the second apparatus, an indication that at least one of said potential anchors of the received message is not the selected or deselected anchor.

According to a fourth aspect, there is provided an apparatus for a second apparatus, the apparatus comprising means for: signalling, to a first apparatus comprising a reinforcement learning agent, a request to select or deselect an anchor for determining a location of the first and/or second apparatus, the request comprising an indication of at least one potential anchor; receiving, from the first apparatus, a request for information related to at least one of: a resource availability of the at least one potential anchor, an energy state of the at least one potential anchor, or an indication of whether the at least one potential anchor is synchronised to a network; and providing the requested information to the first apparatus.

The apparatus may comprise means for: receiving, from the first apparatus, a request for second information related to at least one of a velocity of the at least one potential anchor; a coarse displacement from the first apparatus to the at least one potential anchor; a confidence level associated with a positioning of the at least one potential anchor; or an indication of at least one positioning capability of the at least one potential anchor; and signalling said second information to the first apparatus.

The apparatus may comprise means for: receiving, from the first apparatus, a request for third information related to at least one of: an indication of a type of anchor of the at least one potential anchor; a channel impulse response associated with a channel of the at least one potential anchor that is used for performing positioning-related measurements; an indication of whether a channel of the at least one potential anchor that is used for performing positioning-related measurements is line-of-sight; an indication of, at the apparatus whose location is to be determined, a received power of at least one signal transmitted by the at least one potential anchor; an indication of, at the apparatus whose location is to be determined, an interference level of at least one signal transmitted by the at least one potential anchor; or an indication of a velocity of the apparatus whose location is to be determined; and signalling said third information to the first apparatus.

The apparatus may comprise means for: receiving, from the first apparatus, an evaluation of the anchor for use in determining whether to use the anchor for performing positioning measurements, wherein the evaluation comprises at least one of: a probability distribution to be used for selecting and/or deselecting the anchor for use when performing positioning measurements; that the evaluated anchor is to be selected; that the evaluated anchor is to be deselected; a weight, priority, or rank to be used for selecting and/or deselecting the anchor for use when performing positioning measurements.

The first apparatus may be a user equipment, and the second apparatus may be a location management function.

The first apparatus may be a location management function, and the second apparatus may be a user equipment.

The first apparatus may be a first user equipment and the second apparatus may be a second user equipment.

The apparatus may comprise means for: signalling, from the first apparatus to the second apparatus, an indication that at least one of said potential anchors of the received message is the selected or deselected anchor.

The apparatus may comprise means for: signalling, from the first apparatus to the second apparatus, an indication that at least one of said potential anchors of the received message is not the selected or deselected anchor.

According to a fifth aspect, there is provided an apparatus for a reinforcement learning agent located at a first apparatus, the apparatus comprising: at least one processor; and at least one memory comprising code that, when executed by the at least one processor, causes the apparatus to: receive, from a second apparatus, a request to select and/or deselect an anchor for determining a location of the first and/or second apparatus, the request comprising an indication of at least one potential anchor; request, from a radio access network apparatus and/or the second apparatus, and/or the at least one potential anchor, first information related to at least one of: a resource availability of the at least one potential anchor, an energy state of the at least one potential anchor, or an indication of whether the at least one potential anchor is synchronised to a network; receive the requested first information; evaluate selecting and/or deselecting the anchor using the requested information; and signal the evaluation to the second apparatus.

The evaluating the anchor using the requested information may comprise: constructing a state representation of an environment surrounding the apparatus whose location is to be determined; inputting the state representation into a reinforcement learning model configured to output an evaluation of whether the anchor is to be selected and/or deselected given a set of environmental parameters as an input; and outputting the evaluation.

The reinforcement learning model may be trained prior to said inputting, wherein training the reinforcement learning model may be caused to perform at least one of: calculating a positioning accuracy and/or latency of a position determined using an anchor selected and/or deselected by the reinforcement learning model to form a first positioning accuracy and/or latency; or receiving, from the second apparatus, a second calculated positioning accuracy and/or latency of a position determined using an anchor selected and/or deselected by the reinforcement learning model.

The apparatus may be caused to: use the first and/or second calculated positioning accuracy and/or latency to form a reward signal; input the reward signal into the reinforcement learning model; and determine whether to modify the reinforcement learning model in dependence on the reward signal.

The apparatus may be caused to: receive, from a third apparatus, a third calculated positioning accuracy and/or latency of a position determined using an anchor selected by the reinforcement learning model; and use the third calculated positioning accuracy and/or latency to form the reward signal.

The evaluating the anchor may comprise evaluating a suitability of the at least one potential anchor for being selected and/or deselected.

The apparatus may be caused to: request, from a radio access network apparatus and/or the second apparatus, and/or the at least one potential anchor, second information related to at least one of: a velocity of the at least one potential anchor; a coarse displacement from the first apparatus to the at least one potential anchor; a confidence level associated with a positioning of the at least one potential anchor; or an indication of at least one positioning capability of the at least one potential anchor; and use said second information when selecting or deselecting the anchor.

The apparatus may be caused to: request, from a radio access network apparatus and/or the second apparatus, and/or the at least one potential anchor, third information related to at least one of: an indication of a type of anchor of the at least one potential anchor; a channel impulse response associated with a channel of the at least one potential anchor that is used for performing positioning-related measurements; an indication of whether a channel of the at least one potential anchor that is used for performing positioning-related measurements is line-of-sight; an indication of, at the apparatus whose location is to be determined, a received power of at least one signal transmitted by the at least one potential anchor; an indication of, at the apparatus whose location is to be determined, an interference level of at least one signal transmitted by the at least one potential anchor; or an indication of a velocity of the apparatus whose location is to be determined; and use said second information when selecting the anchor.

The evaluating the anchor may comprise evaluating the anchor for the second apparatus and a third apparatus.

The evaluation may comprise at least one of: a probability distribution to be used for selecting and/or deselecting the anchor for use when performing positioning measurements; that the evaluated anchor is to be selected; that the evaluated anchor is to be deselected; a weight, priority, or rank to be used for selecting and/or deselecting the anchor for use when performing positioning measurements.

The first apparatus may be a user equipment, and the second apparatus may be a location management function.

The first apparatus may be a location management function, and the second apparatus may be a user equipment.

The first apparatus may be a first user equipment and the second apparatus may be a second user equipment.

The apparatus may be caused to: signal, from the first apparatus to the second apparatus, an indication that at least one of said potential anchors of the received message is the selected or deselected anchor.

The apparatus may be caused to: signal, from the first apparatus to the second apparatus, an indication that at least one of said potential anchors of the received message is not the selected or deselected anchor.

According to a sixth aspect, there is provided an apparatus for a second apparatus, the apparatus comprising: at least one processor; and at least one memory comprising code that, when executed by the at least one processor, causes the apparatus to: signal, to a first apparatus comprising a reinforcement learning agent, a request to select or deselect an anchor for determining a location of the first and/or second apparatus, the request comprising an indication of at least one potential anchor; receive, from the first apparatus, a request for information related to at least one of: a resource availability of the at least one potential anchor, an energy state of the at least one potential anchor, or an indication of whether the at least one potential anchor is synchronised to a network; and provide the requested information to the first apparatus.

The apparatus may be caused to: receive, from the first apparatus, a request for second information related to at least one of a velocity of the at least one potential anchor; a coarse displacement from the first apparatus to the at least one potential anchor; a confidence level associated with a positioning of the at least one potential anchor; or an indication of at least one positioning capability of the at least one potential anchor; and signal said second information to the first apparatus.

The apparatus may be caused to: receive, from the first apparatus, a request for third information related to at least one of: an indication of a type of anchor of the at least one potential anchor; a channel impulse response associated with a channel of the at least one potential anchor that is used for performing positioning-related measurements; an indication of whether a channel of the at least one potential anchor that is used for performing positioning-related measurements is line-of-sight; an indication of, at the apparatus whose location is to be determined, a received power of at least one signal transmitted by the at least one potential anchor; an indication of, at the apparatus whose location is to be determined, an interference level of at least one signal transmitted by the at least one potential anchor; or an indication of a velocity of the apparatus whose location is to be determined; and signal said third information to the first apparatus.

The apparatus may be caused to: receive, from the first apparatus, an evaluation of the anchor for use in determining whether to use the anchor for performing positioning measurements, wherein the evaluation comprises at least one of: a probability distribution to be used for selecting and/or deselecting the anchor for use when performing positioning measurements; that the evaluated anchor is to be selected; that the evaluated anchor is to be deselected; a weight, priority, or rank to be used for selecting and/or deselecting the anchor for use when performing positioning measurements.

The first apparatus may be a user equipment, and the second apparatus may be a location management function.

The first apparatus may be a location management function, and the second apparatus may be a user equipment.

The first apparatus may be a first user equipment and the second apparatus may be a second user equipment.

The apparatus may be caused to: signal, from the first apparatus to the second apparatus, an indication that at least one of said potential anchors of the received message is the selected or deselected anchor.

The apparatus may be caused to: signal, from the first apparatus to the second apparatus, an indication that at least one of said potential anchors of the received message is not the selected or deselected anchor.

According to a seventh aspect, there is provided an apparatus for a reinforcement learning agent located at a first apparatus, the apparatus comprising: receiving circuitry for receiving, from a second apparatus, a request to select and/or deselect an anchor for determining a location of the first and/or second apparatus, the request comprising an indication of at least one potential anchor; requesting circuitry for requesting, from a radio access network apparatus and/or the second apparatus, and/or the at least one potential anchor, first information related to at least one of: a resource availability of the at least one potential anchor, an energy state of the at least one potential anchor, or an indication of whether the at least one potential anchor is synchronised to a network; receiving circuitry for receiving the requested first information; evaluating circuitry for evaluating selecting and/or deselecting the anchor using the requested information; and signalling circuitry for signalling the evaluation to the second apparatus.

The evaluating circuitry for evaluating the anchor using the requested information may comprise: constructing circuitry for constructing a state representation of an environment surrounding the apparatus whose location is to be determined; inputting circuitry for inputting the state representation into a reinforcement learning model configured to output an evaluation of whether the anchor is to be selected and/or deselected given a set of environmental parameters as an input; and outputting circuitry for outputting the evaluation.

The reinforcement learning model may be trained prior to said inputting, wherein training the reinforcement learning model may comprise performing circuitry for performing at least one of: calculating a positioning accuracy and/or latency of a position determined using an anchor selected and/or deselected by the reinforcement learning model to form a first positioning accuracy and/or latency; or receiving, from the second apparatus, a second calculated positioning accuracy and/or latency of a position determined using an anchor selected and/or deselected by the reinforcement learning model.

The apparatus may comprise: using circuitry for using the first and/or second calculated positioning accuracy and/or latency to form a reward signal; inputting circuitry for inputting the reward signal into the reinforcement learning model; and determining circuitry for determining whether to modify the reinforcement learning model in dependence on the reward signal.

The apparatus may comprise: receiving circuitry for receiving, from a third apparatus, a third calculated positioning accuracy and/or latency of a position determined using an anchor selected by the reinforcement learning model; and using circuitry for using the third calculated positioning accuracy and/or latency to form the reward signal.

The evaluating circuitry for evaluating the anchor may comprise evaluating circuitry for evaluating a suitability of the at least one potential anchor for being selected and/or deselected.

The apparatus may comprise: requesting circuitry for requesting, from a radio access network apparatus and/or the second apparatus, and/or the at least one potential anchor, second information related to at least one of: a velocity of the at least one potential anchor; a coarse displacement from the first apparatus to the at least one potential anchor; a confidence level associated with a positioning of the at least one potential anchor; or an indication of at least one positioning capability of the at least one potential anchor; and using circuitry for using said second information when selecting or deselecting the anchor.

The apparatus may comprise: requesting circuitry for requesting, from a radio access network apparatus and/or the second apparatus, and/or the at least one potential anchor, third information related to at least one of: an indication of a type of anchor of the at least one potential anchor; a channel impulse response associated with a channel of the at least one potential anchor that is used for performing positioning-related measurements; an indication of whether a channel of the at least one potential anchor that is used for performing positioning-related measurements is line-of-sight; an indication of, at the apparatus whose location is to be determined, a received power of at least one signal transmitted by the at least one potential anchor; an indication of, at the apparatus whose location is to be determined, an interference level of at least one signal transmitted by the at least one potential anchor; or an indication of a velocity of the apparatus whose location is to be determined; and using circuitry for using said second information when selecting the anchor.

The evaluating circuitry for evaluating the anchor may comprise evaluating circuitry for evaluating the anchor for the second apparatus and a third apparatus.

The evaluation may comprise at least one of: a probability distribution to be used for selecting and/or deselecting the anchor for use when performing positioning measurements; that the evaluated anchor is to be selected; that the evaluated anchor is to be deselected; a weight, priority, or rank to be used for selecting and/or deselecting the anchor for use when performing positioning measurements.

The first apparatus may be a user equipment, and the second apparatus may be a location management function.

The first apparatus may be a location management function, and the second apparatus may be a user equipment.

The first apparatus may be a first user equipment and the second apparatus may be a second user equipment.

The apparatus may comprise: signalling circuitry for signalling, from the first apparatus to the second apparatus, an indication that at least one of said potential anchors of the received message is the selected or deselected anchor.

The apparatus may comprise: signalling circuitry for signalling, from the first apparatus to the second apparatus, an indication that at least one of said potential anchors of the received message is not the selected or deselected anchor.

According to an eighth aspect, there is provided an apparatus for a second apparatus, the apparatus comprising: signalling circuitry for signalling, to a first apparatus comprising a reinforcement learning agent, a request to select or deselect an anchor for determining a location of the first and/or second apparatus, the request comprising an indication of at least one potential anchor; receiving circuitry for receiving, from the first apparatus, a request for information related to at least one of:
a resource availability of the at least one potential anchor, an energy state of the at least one potential anchor, or an indication of whether the at least one potential anchor is synchronised to a network; and providing circuitry for providing the requested information to the first apparatus.

The apparatus may comprise: receiving circuitry for receiving, from the first apparatus, a request for second information related to at least one of a velocity of the at least one potential anchor; a coarse displacement from the first apparatus to the at least one potential anchor; a confidence level associated with a positioning of the at least one potential anchor; or an indication of at least one positioning capability of the at least one potential anchor; and signalling circuitry for signalling said second information to the first apparatus.

The apparatus may comprise: receiving circuitry for receiving, from the first apparatus, a request for third information related to at least one of: an indication of a type of anchor of the at least one potential anchor; a channel impulse response associated with a channel of the at least one potential anchor that is used for performing positioning-related measurements; an indication of whether a channel of the at least one potential anchor that is used for performing positioning-related measurements is line-of-sight; an indication of, at the apparatus whose location is to be determined, a received power of at least one signal transmitted by the at least one potential anchor; an indication of, at the apparatus whose location is to be determined, an interference level of at least one signal transmitted by the at least one potential anchor; or an indication of a velocity of the apparatus whose location is to be determined; and signalling circuitry for signalling said third information to the first apparatus.

The apparatus may comprise: receiving circuitry for receiving, from the first apparatus, an evaluation of the anchor for use in determining whether to use the anchor for performing positioning measurements, wherein the evaluation comprises at least one of: a probability distribution to be used for selecting and/or deselecting the anchor for use when performing positioning measurements; that the evaluated anchor is to be selected; that the evaluated anchor is to be deselected; a weight, priority, or rank to be used for selecting and/or deselecting the anchor for use when performing positioning measurements.

The first apparatus may be a user equipment, and the second apparatus may be a location management function.

The first apparatus may be a location management function, and the second apparatus may be a user equipment.

The first apparatus may be a first user equipment and the second apparatus may be a second user equipment.

The apparatus may comprise: signalling circuitry for signalling, from the first apparatus to the second apparatus, an indication that at least one of said potential anchors of the received message is the selected or deselected anchor.

The apparatus may comprise: signalling circuitry for signalling, from the first apparatus to the second apparatus, an indication that at least one of said potential anchors of the received message is not the selected or deselected anchor.

According to a ninth aspect, there is provided non-transitory computer readable medium comprising program instructions for causing an apparatus for a reinforcement learning agent located at a first apparatus, to perform: receive, from a second apparatus, a request to select and/or deselect an anchor for determining a location of the first and/or second apparatus, the request comprising an indication of at least one potential anchor; request, from a radio access network apparatus and/or the second apparatus, and/or the at least one potential anchor, first information related to at least one of: a resource availability of the at least one potential anchor, an energy state of the at least one potential anchor, or an indication of whether the at least one potential anchor is synchronised to a network; receive the requested first information; evaluate selecting and/or deselecting the anchor using the requested information; and signal the evaluation to the second apparatus.

The evaluating the anchor using the requested information may comprise: constructing a state representation of an environment surrounding the apparatus whose location is to be determined; inputting the state representation into a reinforcement learning model configured to output an evaluation of whether the anchor is to be selected and/or deselected given a set of environmental parameters as an input; and outputting the evaluation.

The reinforcement learning model may be trained prior to said inputting, wherein training the reinforcement learning model may be caused to perform at least one of: calculating a positioning accuracy and/or latency of a position determined using an anchor selected and/or deselected by the reinforcement learning model to form a first positioning accuracy and/or latency; or receiving, from the second apparatus, a second calculated positioning accuracy and/or latency of a position determined using an anchor selected and/or deselected by the reinforcement learning model.

The apparatus may be caused to: use the first and/or second calculated positioning accuracy and/or latency to form a reward signal; input the reward signal into the reinforcement learning model; and determine whether to modify the reinforcement learning model in dependence on the reward signal.

The apparatus may be caused to: receive, from a third apparatus, a third calculated positioning accuracy and/or latency of a position determined using an anchor selected by the reinforcement learning model; and use the third calculated positioning accuracy and/or latency to form the reward signal.

The evaluating the anchor may comprise evaluating a suitability of the at least one potential anchor for being selected and/or deselected.

The apparatus may be caused to: request, from a radio access network apparatus and/or the second apparatus, and/or the at least one potential anchor, second information related to at least one of: a velocity of the at least one potential anchor; a coarse displacement from the first apparatus to the at least one potential anchor; a confidence level associated with a positioning of the at least one potential anchor; or an indication of at least one positioning capability of the at least one potential anchor; and use said second information when selecting or deselecting the anchor.

The apparatus may be caused to: request, from a radio access network apparatus and/or the second apparatus, and/or the at least one potential anchor, third information related to at least one of: an indication of a type of anchor of the at least one potential anchor; a channel impulse response associated with a channel of the at least one potential anchor that is used for performing positioning-related measurements; an indication of whether a channel of the at least one potential anchor that is used for performing positioning-related measurements is line-of-sight; an indication of, at the apparatus whose location is to be determined, a received power of at least one signal transmitted by the at least one potential anchor; an indication of, at the apparatus whose location is to be determined, an interference level of at least one signal transmitted by the at least one potential anchor; or an indication of a velocity of the apparatus whose location is to be determined; and use said second information when selecting the anchor.

The evaluating the anchor may comprise evaluating the anchor for the second apparatus and a third apparatus.

The evaluation may comprise at least one of: a probability distribution to be used for selecting and/or deselecting the anchor for use when performing positioning measurements; that the evaluated anchor is to be selected; that the evaluated anchor is to be deselected; a weight, priority, or rank to be used for selecting and/or deselecting the anchor for use when performing positioning measurements.

The first apparatus may be a user equipment, and the second apparatus may be a location management function.

The first apparatus may be a location management function, and the second apparatus may be a user equipment.

The first apparatus may be a first user equipment and the second apparatus may be a second user equipment.

The apparatus may be caused to: signal, from the first apparatus to the second apparatus, an indication that at least one of said potential anchors of the received message is the selected or deselected anchor.

The apparatus may be caused to: signal, from the first apparatus to the second apparatus, an indication that at least one of said potential anchors of the received message is not the selected or deselected anchor.

According to a tenth aspect, there is provided non-transitory computer readable medium comprising program instructions for causing an apparatus: signal, to a second apparatus, a request to select or deselect an anchor for determining a location of the first and/or second apparatus, the request comprising an indication of at least one potential anchor; receive, from the first apparatus, a request for information related to at least one of: a resource availability of the at least one potential anchor, an energy state of the at least one potential anchor, or an indication of whether the at least one potential anchor is synchronised to a network; and provide the requested information to the first apparatus.

The apparatus may be caused to: receive, from the first apparatus, a request for second information related to at least one of a velocity of the at least one potential anchor; a coarse displacement from the first apparatus to the at least one potential anchor; a confidence level associated with a positioning of the at least one potential anchor; or an indication of at least one positioning capability of the at least one potential anchor; and signal said second information to the first apparatus.

The apparatus may be caused to: receive, from the first apparatus, a request for third information related to at least one of: an indication of a type of anchor of the at least one potential anchor; a channel impulse response associated with a channel of the at least one potential anchor that is used for performing positioning-related measurements; an indication of whether a channel of the at least one potential anchor that is used for performing positioning-related measurements is line-of-sight; an indication of, at the apparatus whose location is to be determined, a received power of at least one signal transmitted by the at least one potential anchor; an indication of, at the apparatus whose location is to be determined, an interference level of at least one signal transmitted by the at least one potential anchor; or an indication of a velocity of the apparatus whose location is to be determined; and signal said third information to the first apparatus.

The apparatus may be caused to: receive, from the first apparatus, an evaluation of the anchor for use in determining whether to use the anchor for performing positioning measurements, wherein the evaluation comprises at least one of: a probability distribution to be used for selecting and/or deselecting the anchor for use when performing positioning measurements; that the evaluated anchor is to be selected; that the evaluated anchor is to be deselected; a weight, priority, or rank to be used for selecting and/or deselecting the anchor for use when performing positioning measurements.

The first apparatus may be a user equipment, and the second apparatus may be a location management function.

The first apparatus may be a location management function, and the second apparatus may be a user equipment.

The first apparatus may be a first user equipment and the second apparatus may be a second user equipment.

The apparatus may be caused to: signal, from the first apparatus to the second apparatus, an indication that at least one of said potential anchors of the received message is the selected or deselected anchor.

The apparatus may be caused to: signal, from the first apparatus to the second apparatus, an indication that at least one of said potential anchors of the received message is not the selected or deselected anchor.

According to an eleventh aspect, there is provided a computer program product stored on a medium that may cause an apparatus to perform any method as described herein.

According to a twelfth aspect, there is provided an electronic device that may comprise apparatus as described herein.

According to a thirteenth aspect, there is provided a chipset that may comprise an apparatus as described herein.

### BRIEF DESCRIPTION OF FIGURES

Some examples, will now be described, merely by way of illustration only, with reference to the accompanying drawings in which:

FIGS. 1A and 1B show a schematic representation of a 5G system;

FIG. 2 shows a schematic representation of a network apparatus;

FIG. 3 shows a schematic representation of a user equipment;

FIG. 4 shows a schematic representation of a non-volatile memory medium storing instructions which when executed by a processor allow a processor to perform one or more of the steps of the methods of some examples;

FIG. 5 shows a schematic representation of a network;

FIGS. 6 to 8 illustrate different architectures;

FIGS. 9 to 10 illustrate example signalling between apparatus described herein; and

FIGS. 11 to 12 illustrate example operations that may be performed by apparatus described herein.

### DETAILED DESCRIPTION

In the following description of examples, certain aspects are explained with reference to mobile communication devices capable of communication via a wireless cellular system and mobile communication systems serving such mobile communication devices. For brevity and clarity, the following describes such aspects with reference to a 5G wireless communication system. However, it is understood that such aspects are not limited to 5G wireless communication systems, and may, for example, be applied to other wireless communication systems (for example, current 6G proposals).

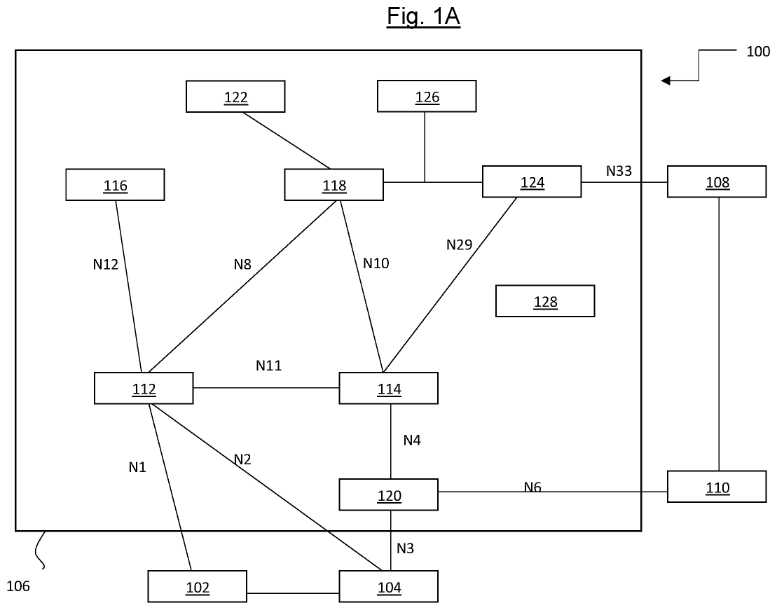

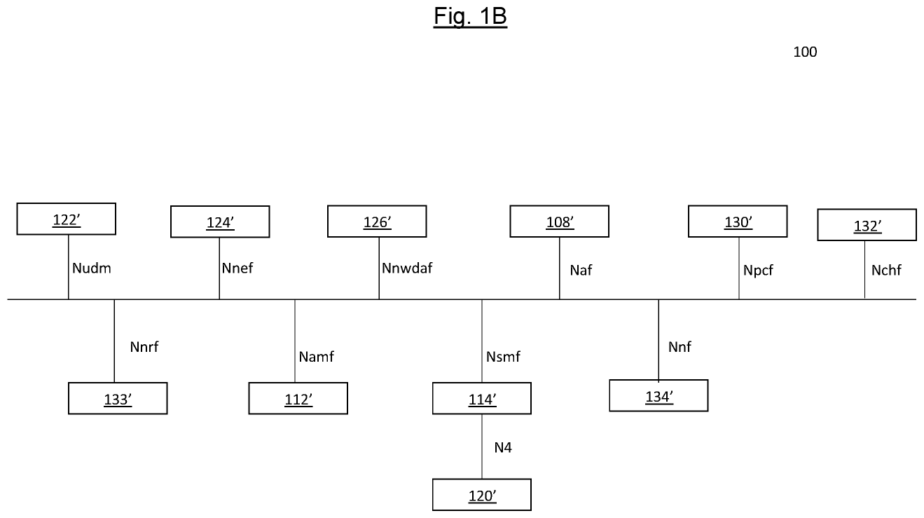

Before describing in detail the examples, certain general principles of a 5G wireless communication system are briefly explained with reference to FIGS. 1A and 1B.

FIG. 1A shows a schematic representation of a 5G system (5GS) 100. The 5GS may comprise a user equipment (UE) 102 (which may also be referred to as a communication device or a terminal), a 5G access network (AN) (which may be a 5G Radio Access Network (RAN) or any other type of 5G AN such as a Non-3GPP Interworking Function (N3IWF)/a Trusted Non3GPP Gateway Function (TNGF) for Untrusted/Trusted Non-3GPP access or Wireline Access Gateway Function (W-AGF) for Wireline access) 104, a 5G core (5GC) 106, one or more application functions (AF) 108 and one or more data networks (DN) 110.

The 5G RAN may comprise one or more gNodeB (gNB) distributed unit functions connected to one or more gNodeB (gNB) unit functions. The RAN may comprise one or more access nodes.

The 5GC 106 may comprise one or more Access and Mobility Management Functions (AMF) 112, one or more Session Management Functions (SMF) 114, one or more authentication server functions (AUSF) 116, one or more unified data management (UDM) functions 118, one or more user plane functions (UPF) 120, one or more unified data repository (UDR) functions 122, one or more network repository functions (NRF) 128, and/or one or more network exposure functions (NEF) 124. The role of an NEF is to provide secure exposure of network services (e.g. voice, data connectivity, charging, subscriber data, and so forth) towards a 3rd party. Although NRF 128 is not depicted with its interfaces, it is understood that this is for clarity reasons and that NRF 128 may have a plurality of interfaces with other network functions.

The 5GC 106 also comprises a network data analytics function (NWDAF) 126. The NWDAF is responsible for providing network analytics information upon request from one or more network functions or apparatus within the network. Network functions can also subscribe to the NWDAF 126 to receive information therefrom. Accordingly, the NWDAF 126 is also configured to receive and store network information from one or more network functions or apparatus within the network. The data collection by the NWDAF 126 may be performed based on at least one subscription to the events provided by the at least one network function.

The network may further comprise a management data analytics service (MDAS) producer or MDAS Management Service (MnS) producer. The MDAS MnS producer may provide data analytics in the management plane considering parameters including, for example, load level and/or resource utilization. For example, the MDAS MnS producer for a network function (NF) may collect the NF's load-related performance data, e.g., resource usage status of the NF. The analysis of the collected data may provide forecast of resource usage information in a predefined future time window. This analysis may also recommend appropriate actions e.g., scaling of resources, admission control, load balancing of traffic, and so forth.

FIG. 1B shows a schematic representations of a 5GC represented in current 3GPP specifications. It is understood that this architecture is intended to illustrate potential components that may be comprised in a core network, and the presently described principles are not limited to core networks comprising only the described components.

FIG. 1B shows a 5GC 106′ comprising a UPF 120′ connected to an SMF 114′ over an N4 interface. The SMF 114′ is connected to each of a UDM 122′, an NEF 124′, an NWDAF 126′, an AF 108′, a Policy Control Function (PCF) 130′, an AMF 112′, and a Charging function 132′ over an interconnect medium that also connects these network functions to each other. The 5G core 106′ further comprises a network repository function (NRF) 133′ and a network function 134′ that connect to the interconnect medium.

NG-Radio Access Network (NG-RAN) supports Multi-Radio Dual Connectivity (MR-DC) operation whereby a UE in RRC_CONNECTED is configured to utilise radio resources provided by two distinct schedulers, located in two different NG-RAN nodes connected via a non-ideal backhaul, one providing New Radio (NR) access and the other one providing either Evolved UMTS Terrestrial Radio Access Network (E-UTRA) or NR access. One of these nodes (a master node (MN) may establish a UE context at secondary node (SN) for providing resources from the SN to the UE. Example MR-DC operations include Conditional Primary cell of secondary cell group (PSCell) change (CPC) and Conditional PSCell addition (CPA).

CPC is a PSCell change procedure that is executed only when PSCell execution condition(s) are met.

In more detail, when a CPC for a source PSCell is configured in the UE by an MN using an RRCReconfiguration message, the UE maintains a connection with the source PSCell after receiving the CPC configuration and starts evaluating the CPC execution conditions for candidate PSCell(s) comprised in the RRCReconfiguration message. A network can configure a UE with up to 8 candidate PSCell configuration(s) with associated execution condition(s). If at least one CPC candidate PSCell satisfies the corresponding CPC execution condition, the UE detaches from the source PSCell, applies the stored corresponding configuration for the selected candidate PSCell and synchronises to that candidate PSCell. The UE completes the CPC execution procedure by either the MN with signalling an embedded RRCReconfigurationComplete message for forwarding to the new PSCell (i.e., to the selected candidate PSCell), or by sending the RRCReconfigurationComplete message directly to the new PSCell.

3GPP refers to a group of organizations that develop and release different standardized communication protocols. 3GPP develops and publishes documents pertaining to a system of “Releases” (e.g., Release 15, Release 16, and beyond).

The present disclosure relates to using artificial intelligence/machine learning (AI/ML) for enhanced positioning, which is one of the three use cases in the 3GPP Release 18 Study Item on AI/ML for Air Interface. The goal of the study item is to enable improved support of AI/ML-based algorithms for enhanced performance and/or reduced complexity and/or overhead for the defined use cases.

For positioning, 3GPP offers Radio access technology (RAT)-dependent positioning methods that use Long Term Evolution (LTE) and/or New Radio (NR) radio signals transmitted between UEs and at least one access point, such as, for example, Transmission Reception points (TRP) and/or gNBs. Support for RAT-independent methods, such as those based on global navigation satellite system (GNSS) techniques and/or sensors is also provided, such as with the provision of assistance data. More recently, a study item on sidelink positioning aims at exploiting UE-type devices (such as, for example, conventional UEs, Road Side Units (RSUs), Positioning Reference Units (PRUs)) as positioning anchors, using RAT-dependent techniques for improving a positioning estimate of other UEs. In the context of the following, the term “anchor” may refer to an apparatus whose position is known to a predetermined level of confidence. Sidelink positioning is an enabler for use cases including vehicle-2-anything (V2X), public safety, Industrial Internet of Things (IIoT), and/or commercial use cases. RSUs may be considered to be geographically-fixed UE-type devices that are deployed alongside the roads for intelligent transportation systems. PRUs may be considered to be UEs with positioning functionality and a known location.

One of the challenges in determining a position of an entity is the selection of positioning anchors for performing positioning measurements. Various factors related to anchors have a direct impact on the positioning accuracy. These include, for example, a channel quality between the target UE and the anchors (e.g., Line of Sight (LOS), non-line of sight (NLOS), signal to interference and noise ratio (SINR), etc.), the geometric arrangement of the positioning anchors, which impacts the geometric dilution of precision (GDOP), the level of confidence in the anchor locations, and a relative distance and/or speed between the anchors and the target UE.

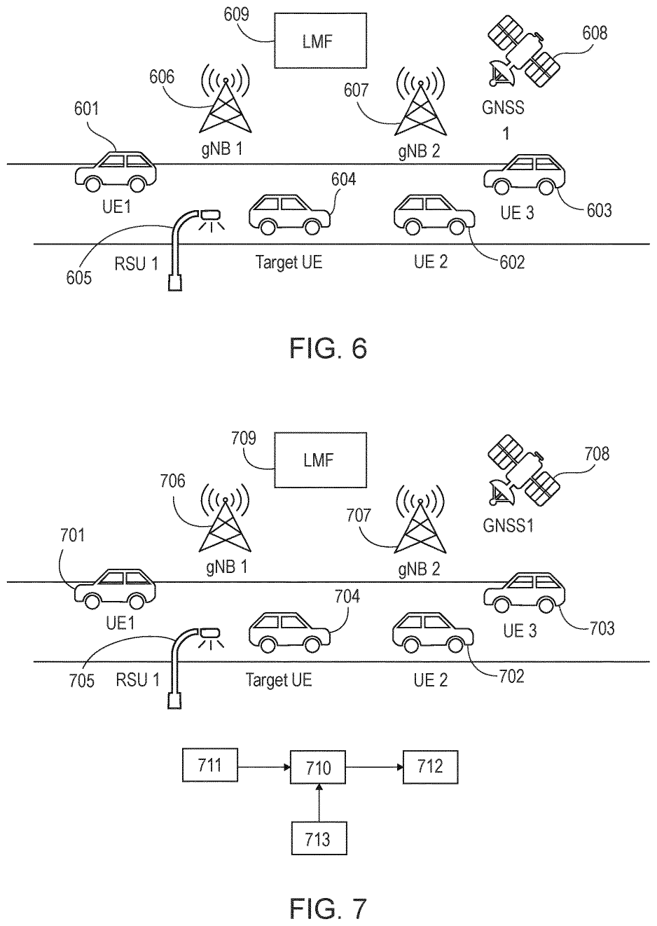

At least one of these issues is illustrated with respect to FIG. 6.

FIG. 6 illustrates a first UE 601, a second UE 602, a third UE 603, and a target UE 604. The first, second, third and target UEs may be configured such that they may move independently relative to each other. FIG. 6 further illustrates an RSU 605, first and second access points 606, 607, and a GNSS satellite 608. Also illustrated is a location management function (LMF) 609, which is located in the 5G core and is accessible via the first and second access points 606, 607.

The arrangement of FIG. 6 illustrates how anchor selection is further complicated when a set of heterogeneous anchors having different mobility and characteristics are available at a given time.

For example, considering mobility, mobility conditions constantly impact the above factors. This means that dynamic selection of anchors for a mobile target UE may need to be optimised. Further, new nodes enter/exit the range of the target UE, as the target UE moves.

As another example, we consider heterogeneity of anchors. When combined with mobility, a variety of anchor types may become available at a given time, such as, for example, gNB/transmission reception points, Global Navigation Satellite System, UE, RSUs, PRUs, etc. Different anchor types may have different characteristics such as being static or mobile, having a known/unknown location, and/or different interfaces to the target UE (for example, uplink interfaces/downlink interfaces/sidelink interfaces, etc.).

Further, depending on the scenario, UEs might make use of different types of anchors. For example, when there is not sufficient number of TRPs available, UEs may resort to using other UEs for positioning. Similarly, for ranging purposes, which is important for V2X use cases, UEs can simply select other UEs nearby as anchors for performing relative distance and/or angle estimations using sidelink interfaces.

The problem of selecting an anchor, especially under mobile and dynamic conditions, has not yet been sufficiently tackled in 3GPP. However, under NR enhanced positioning, users should be able to determine their positioning regardless of whether they are located in full network coverage, partial network coverage, or outside network coverage, including when they are mobile.

Some proposals have previously been made for determining a position of the user equipment.

For example, approaches in the literature rely on various channel metrics between the UEs and anchors for use in determining a position. Example channel metrics include Line of Sight (LOS)/non-LOS (NLOS) classifications, Time of Arrival (ToA) of positioning signals, etc., Based on such metrics, anchors are then selected (or not selected) in dependence on whether or not their signal properties satisfy certain criteria. For example, an anchor may be selected or not selected depending on whether it has an associated a channel metric value below or above a specific threshold. However, such approaches might become inefficient under mobile conditions, where the thresholds need to be dynamically adjusted, which may be the case when there are varying channel conditions.

Therefore, achieving high-accuracy positioning necessitates efficient methods for the anchor selection task that are adaptable to dynamic conditions in the environment.

The following proposes to address at least one of the above-mentioned issues by providing a reinforcement learning—(RL) based approach to the positioning anchor selection problem.

Reinforcement learning focuses on training agents to take any action at a particular stage in an environment to maximise rewards. Reinforcement learning then tries to train the model to improve itself and its choices by observing rewards through interactions with the environment.

RL has particular accuracy in handling tasks in time-varying dynamic environments under uncertainty, and has recently found promising applications in the wireless communications domain.

This mechanism is illustrated with respect to FIG. 7.

FIG. 7 illustrates a first UE 701, a second UE 702, a third UE 703, and a target UE 704. The first, second, third and target UEs may be configured such that they may move independently relative to each other. FIG. 7 further illustrates an RSU 705, first and second access points 706, 707, and a GNSS satellite 708. Also illustrated is a location management function (LMF) 709, which is located in the 5G core and is accessible via the first and second access points 706, 707.

In addition, FIG. 7 illustrates an RL-based approach that may be implemented by an RL agent 710 located in a node. This RL agent may receive an input 711 indicating a state of the radio environment surrounding the target UE 704. For example, the input may indicate at least one of: any anchor that is available for use as an anchor by the UE 704, and/or channel conditions between the target UE 704 and the any anchors. The RL agent may evaluate this input using a policy configured in the RL agent to determine which anchor is selected for use as an anchor. The RL agent may output the selected anchor via output 712. The RL agent may also receive another input 713 for training purposes.

In other words, in the example, of FIG. 7, an RL agent is implemented that makes decisions on anchor selection. These decisions are labelled as “actions”, and are based on observations from the mobile environment, which is labelled as the “state” of the environment. The environment state may comprise several features of potential anchor(s) for selection, such as channel conditions and mobility status of the anchors.

The decisions are based on the agent's policy. The agent's policy may be, for example, represented by a deep neural network, which is trained with the use of a “reward” signal provided upon its each action, via deep reinforcement learning (DRL) techniques. A reward signal indicates how good the action selection was (for example, it may provide feedback indicating the positioning accuracy obtained from the selected anchor).

Training of the RL agent may be conducted offline using known UE locations to calculate accuracy required for the reward signal. Subsequent to being trained, the agent is deployed in the network for real-time inference. During inference, the RL agent may only use the environment state information as an input for selecting an anchor (i.e., no reward/feedback required). However, it is possible to further train an RL agent during use, e.g., for fine tuning purposes in a new environment.

The described RL agent may be implemented either fully or partially in different nodes. For example, the described RL agent may be implemented in any of a UE, an LMF, and/or a gNB.

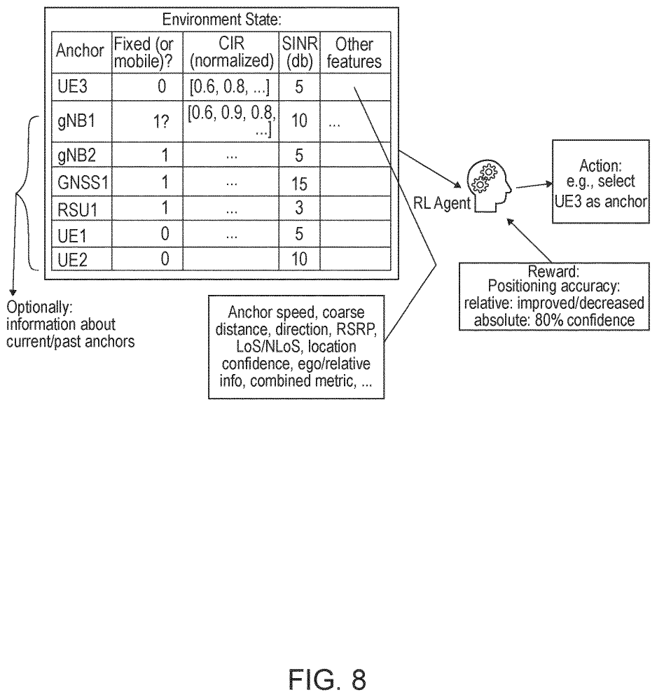

FIGS. 8 to 11 provide further examples illustrating features of the present disclosure.

FIG. 8 illustrates example state information that may be input to an RL agent, which, in the present example, selects UE3 as an anchor. The training input shown in FIG. 8 may indicate that the positioning accuracy has either improved or decreased and/or indicates a confidence in the positioning value relative to an absolute value.

FIG. 8 illustrates an example in which environment state conditions being considered include at least one of: an anchor type, whether the anchor is fixed relative to the UE whose location is to be determined, a channel impulse response for the anchor channel that would be used for positioning, and a Signal to Interference plus noise ratio. However, it is understood that this list is not exhaustive. Further examples of environment/state information are indicated below.

In the example of FIG. 8, the state information comprises of at least one or more of the following information (including their combinations) related to a potential positioning anchor for selection:
1. Anchor type (e.g., gNB, UE, GNSS, etc.)
2. Channel impulse response (CIR)
3. Whether channel is LOS (or NLOS)
4. Received power, e.g., downlink or sidelink Reference Signal Received Power (RSRP)
5. Received Signal to Interference plus noise ratio (SINR) and/or Received Signal Strength Indication (RSSI)
6. Target UE kinematics, e.g., speed, heading/direction, etc.
7. Anchor kinematics, e.g., speed, heading/direction, etc.
8. Coarse distance and/or direction to anchor from the UE
9. Confidence of the location information of the anchor, e.g., in terms of accuracy
10. Positioning-related capabilities of the anchor, e.g., supported positioning techniques, including antenna information, antenna direction and orientation
11. Resource availability of the anchor, e.g., maximum available bandwidth or time/frequency resources, support for various sidelink modes (e.g., support for sidelink mode 1 and/or sidelink mode 2)
12. Energy state (e.g., power status and/or transmit power level) of the anchor
13. Whether the anchor is synchronized to a network or not, and, if so, what the synchronization source is

For example, in a dense indoor factory scenario, the following subset of the above features might be utilized as an input to an RL agent since this scenario considers rather static users and anchors as well as a single RAT: 2, 3, 4, 5, 8.

In another example, besides the potential anchors for selection, the state information may also comprise any of the above information relating to one or more of the currently-selected and/or past selected anchors.

The action output by the RL agent may be provided in any of a plurality of forms.

For example, the output action may indicate that a specific anchor and/or set of anchors is to be selected for providing positioning measurements. As another example, the action may indicate that a specific anchor and/or set of anchors is to be deselected (i.e., not used) for providing positioning measurements.

As another example, the output action may be provided in the form of a probability of selecting a given anchor and/or a set of anchors to be used for positioning measurements/estimation. As another example, the output action may be provided in the form of a probability of deselecting a given anchor and/or a set of anchors to be used for positioning measurements/estimation.

The reward signal provided to the RL agent for training purposes may comprise any of a number of different forms.

For example, the reward signal may be provided in the form of a positioning accuracy. This may be expressed, for example, in terms of a Euclidean distance between an estimated and absolute true value of the position of the selected anchor, using the selected anchor's known location.

In addition or in the alternate, the reward signal may be provided in the form of a positioning latency. For example, the reward signal may be expressed in terms of a time used for obtaining positioning measurements from the selected anchor.

In addition or in the alternate, the reward signal may be provided in the form of a relative improvement of the above metrics over time. For example, the reward signal may be expressed in terms of a percentage of positioning accuracy improvement with respect to a previous positioning estimate.

For example, in one case, the reward signal R may be calculated as follows:

$$R = α \vert \hat{d} - d \vert + β ( {t}_{est} - {t}_{r e q} )$$

where \hat{d} is the true range (i.e., distance) between the target UE and the anchor, d is the estimated range, tₑₛₜ and t_{reg} are respective time instances when the positioning request and when the positioning estimate are available, and α and β are respectively used to adjust weight of each component reflecting the positioning accuracy and latency of an anchor.

In an example, the policy (and/or the value function—which is used to represent the expected long-term reward of a given state) of the agent may be represented by a deep neural network. The policy may be trained by one or more of the following Reinforcement Learning algorithms: Q-learning (e.g., Deep Q-Networks (DQN), in which a memory table Q[s,a] is built to store Q-values for every combination of s and a (which denote state and action respectively). The agent learns a Q-value function that gives an expected total return in a given state and action pair. The agent is configured to act in a way that minimizes this Q-value), policy-gradient (e.g., REINFORCE, Trust Region Policy Optimization (TRPO), Proximal Policy Optimization (PPO), etc. In policy-gradient methods, a policy is directly manipulated to reach the optimal policy that maximises an expected return), actor-critic (e.g., Advantage Actor Critic (A2C), Asynchronous Advantage Actor Critic (A3C), Deep Deterministic Policy Gradient (DDPG), Soft Actor Critic (SAC)), dynamic programming, Monte Carlo, and/or temporal-difference (e.g., State-action-reward-state-action (SARSA)) methods.

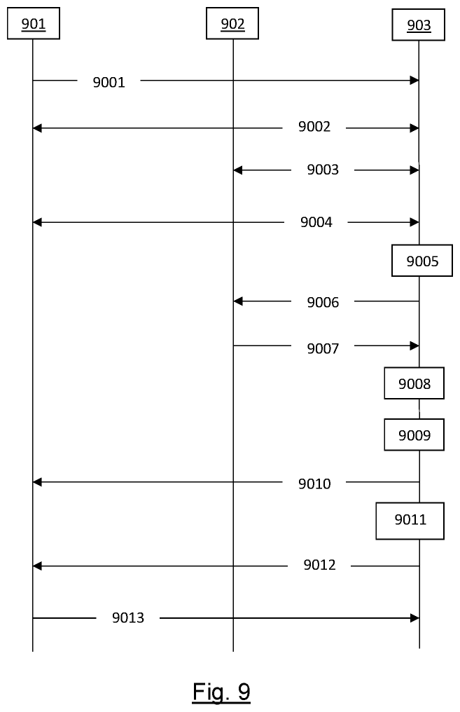

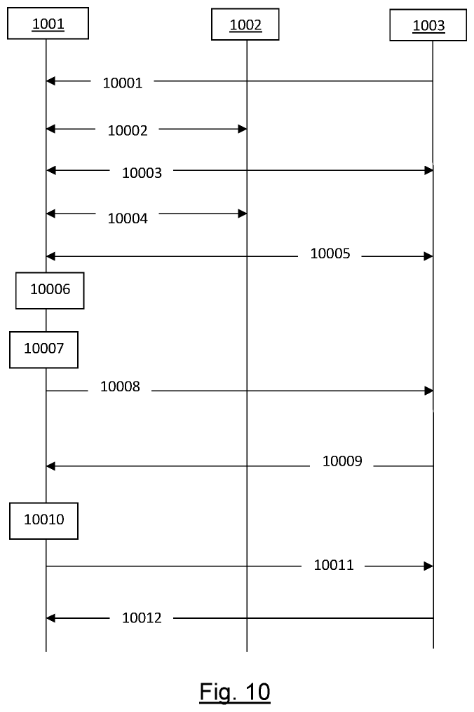

FIGS. 9 and 10 illustrate example signalling that may be performed between apparatus implementing features of the presently described principles.

FIG. 9 illustrates signalling that may be performed between a target UE 901, a potential anchor node 902, and a location management function 903.

In this example of FIG. 9, an RL agent is implemented at the network side (e.g., in an LMF). This may be useful as centralized information available at the network may be used by the RL agent when selecting an anchor.

During 9001, the target UE 901 may signal the LMF 903. This signalling may request a selection of an anchor for assisting the target UE 901 when performing a positioning operation. This signalling of 9001 may comprise an identifier of at least one potential anchor to be considered by the LMF 903. For example, the signalling of 9001 may comprise an identifier of potential anchor node 902.

9002 to 9008 relate to the LMF 903 constructing a state representation of the environment around the target UE 901.

During 9002, the LMF 903 and the target UE 901 exchange signalling. This signalling may enable the LMF 903 to collect information on at least one of: a Channel impulse response (CIR) of the UE, whether the channel being considered is LOS (or NLOS), received power, e.g., downlink or sidelink RSRP, and/or received SINR and/or RSSI.

During 9003, the LMF 903 and the potential anchor node 902 exchange signalling. This signalling may enable the LMF 903 to collect information on at least one of: a Channel impulse response (CIR) of the potential anchor node, whether the channel being considered is LOS (or NLOS), received power, e.g., downlink or sidelink RSRP, and/or received SINR and/or RSSI.

During 9004, the LMF 903 and the target UE 901 exchange signalling. This signalling of 9004 may enable the LMF to collect information on target UE kinematics, e.g., speed, heading/direction, etc.

During 9005, the LMF 903 collects further information on at least one of: an anchor type (e.g., gNB, UE, GNSS, etc.), anchor kinematics, e.g., speed, heading/direction, etc., a coarse distance and/or direction to anchor from the UE, a confidence of the location information of the anchor, e.g., in terms of accuracy, and/or positioning-related capabilities of the anchor, e.g., supported positioning techniques, including antenna information, antenna direction and orientation.

During 9006, the LMF 903 signals the potential anchor node 902. This signalling of 9006 may request information on at least one of: a resource availability of the anchor, e.g., maximum available bandwidth or time/frequency resources, support for various sidelink modes (e.g., support for sidelink mode 1 and/or sidelink mode 2), an energy state (e.g., power status and/or transmit power level) of the anchor, and/or whether the anchor is synchronized to a network or not, and, if so, what the synchronization source is.

During 9007, the potential anchor node 902 signals the LMF 903. This signalling of 9007 may provide the information requested during 9006. It is understood that although 9006 and 9007 are shown as being performed between an LMF 903 and the potential anchor node 902, that this signalling may instead be performed between an LMF 903 and a next generation radio access network (NG-RAN) node.

During 9008, the LMF 905 constructs a state representation using the information received during 9002 to 9007.

During 9009 and 9010, the LMF selects and signals an indication of the selected anchor to the UE.

During 9009, the LMF 903 inputs the state representation constructed during 9008 into an RL model, which outputs an action (i.e., a selected potential anchor node, such as potential anchor node 902).

During 9010, the LMF 903 signals the UE 901. This signaling of 9010 may provide an indication of the selected potential anchor of 9009. Although not shown, the UE may use this information for selecting and/or deselecting an anchor to be used to assist the UE 901 in determining a position of the UE 901.

9011 to 9013 may be performed during a training period of the RL model.

9011 may be performed when the LMF 903 comprises a true location of the target UE 901.

During 9011, the LMF 903 calculates a positioning accuracy and/or latency of the target UE 901 by comparing a position estimated by/for the UE 901 using the selected potential anchor node to the true/known absolute position of the UE 901. Although not shown, the LMF 903 may use this calculated information to train the RL model.

9012 and 9013 may be performed when the LMF 903 does not have a true location of the target UE 901.

During 9012, the LMF 903 signals the UE 901. This signalling of 9012 may request information that may be used by the LMF 903 for determining reward information. Reward information may be pre-defined or pre-configured to both sides (i.e. to both the UE 901 and the LMF 903). For example, the reward information may be pre-configured as |\hat{d}−d|. The reward information may be explicitly requested as “provide me ranging accuracy using anchor(s) X, Y, etc.”.

During 9013, the LMF 903 receives, from the UE 901, the information requested during 9012. This received information may be used to train the model. Therefore, although not shown, the LMF 903 may use the received information to train the model.

FIG. 10 illustrates signalling that may be performed by various entities when an RL agent is implemented at the UE side. Such an implementation has the advantage that it can also work outside the network coverage, which is useful for, for example, sidelink-based positioning.

FIG. 10 illustrates signalling that may be performed between a target UE 1001, a potential anchor node 1002, and an LMF 1003. The target UE 1001 comprises an RL agent.

During 10001, the LMF 1003 signals the target UE 1001. This signalling of 10001 may request a selection of an anchor for assisting the target UE 901 when performing a positioning operation. This signalling of 10001 may comprise an identifier of at least one potential anchor to be considered by the target UE 1001. For example, the signalling of 10001 may comprise an identifier of potential anchor node 1002.

10002 to 10006 relate to the target UE constructing a state representation of the environment in which the target UE is operating.

During 10002, the target UE 1001 exchanges signalling with the potential anchor node 1002. This signalling of 10002 may cause the UE 1001 to be provided with information relating to at least one of: a type of anchor of the potential anchor node(s) being considered (e.g., gNB, UE, GNSS, etc.), a channel impulse response (CIR), information whether the channel is LOS (or NLOS), received power, e.g., downlink or sidelink RSRP, an SINR, and/or an RSSI, and/or kinematics of a target UE, e.g., speed, heading/direction, etc.

During 10003, the target UE 1001 exchanges signalling with the LMF 1003. This signalling of 10003 may cause the UE 1001 to be provided with information relating to at least one of: a type of anchor of the potential anchor node(s) being considered (e.g., gNB, UE, GNSS, etc.), a channel impulse response (CIR), information whether the channel is LOS (or NLOS), received power, e.g., downlink or sidelink RSRP, an SINR, and/or an RSSI, and/or kinematics of a target UE, e.g., speed, heading/direction, etc.

During 10004, the target UE 1001 exchanges signalling with the potential anchor node 1002. This signalling of 10004 may cause the UE 1001 to be provided with information relating to at least one of: anchor kinematics (such as, for example, speed, heading/direction, etc.), a coarse distance and/or direction to anchor from the UE, a confidence of the location information of the anchor (such as, for example, in terms of accuracy, any positioning-related capabilities of the anchor, such as, for example, supported positioning techniques, including antenna information, antenna direction and orientation), resource availability of the anchor (such as, for example, maximum available bandwidth and/or time/frequency resources, support for various sidelink modes (e.g., support for sidelink mode 1 and/or sidelink mode 2)), an energy state of the anchor (such as, for example, a power status and/or transmit power level), and/or whether the anchor is synchronized to a network or not (and, if so, what the synchronization source is).

During 10005, the target UE 1001 exchanges signalling with the LMF 1003. This signalling of 10005 may cause the UE 1001 to be provided with information relating to at least one of: anchor kinematics (such as speed, heading/direction, etc.), a coarse distance and/or direction to anchor from the UE, a confidence of the location information of the anchor (such as in terms of accuracy, any positioning-related capabilities of the anchor, such as, for example, supported positioning techniques, including antenna information, antenna direction and orientation), resource availability of the anchor (such as maximum available bandwidth and/or time/frequency resources, support for various sidelink modes (e.g., support for sidelink mode 1 and/or sidelink mode 2)), an energy state of the anchor (such as a power status and/or transmit power level), and/or whether the anchor is synchronized to a network or not (and, if so, what the synchronization source is).

During 10006, the target UE constructs a state representation using the information received during 10002 to 10005.

During 10007 to 10009, the target UE 1001 selects and signals an indication of the selected anchor to the LMF 1003.

During 10007, the target UE 1001 inputs the state representation constructed during 10006 into an RL model, which outputs an action (i.e., a selected potential anchor node, such as potential anchor node 1002).

During 10008, the target UE 1001 signals the LMF 1003. This signaling of 10008 may provide an indication of the selected potential anchor of 10007. The UE may use this information for selecting and/or deselecting an anchor to be used to assist the UE 1001 in determining a position of the UE 1001.

During 10009, the LMF 1003 signals the target UE 1001. This signaling of 10009 may indicate whether the selected potential anchor of 10007 is allowed to be used by the UE 1001 for performing a positioning estimate of the UE 1001. Although not shown, the UE 1001 may, when the signalling of 10009 indicates that the UE 1001 may use the selected potential anchor of 10007 for performing positioning of the UE 1001, use the selected potential anchor of 10007 for performing positioning of the UE 1001. When the signalling of 10009 indicates that the UE 1001 cannot use the selected potential anchor of 10007 for performing positioning of the UE 1001, not use the selected potential anchor of 10007 for performing positioning of the UE 1001, and instead select a new potential anchor for this purpose instead.

10010 to 10012 may be performed during a training period of the RL model.

10010 may be performed when the target UE 1001 comprises a true location of the target UE 1001.

During 10010, the UE 1001 calculates a positioning accuracy and/or latency of the target UE 1001 by comparing a position estimated by/for the UE 1001 using the selected potential anchor node to the true/known absolute position of the UE 1001. Although not shown, the LMF 1003 may use this calculated information to train the RL model.

10011 and 10012 may be performed when the UE 1001 does not have a true location of the target UE 1001.

During 10011, the target UE 1001 signals the LMF 1003. This signalling of 10011 may request information that may be used by the target UE 1001 for determining reward information.

During 10012, the target UE 1001 receives, from the LMF 1003, the information requested during 10011. This received information may be used to train the RL model. Therefore, although not shown, the target UE 1001 may use the received information to train the model.

Although the above examples illustrate RL model training being performed centrally in a single entity, it is understood that the present disclosure is not limited to this architecture. For example, the RL model may instead be trained in a distributed manner. For example, the training may be performed using multiple UEs. In this example, each UE performing the training may collect at least one set of state, action, reward tuples, which are in turn used to train a single global policy. The single global policy may be, for example, located at the network (e.g., at the LMF). When the trained policy is deployed at the UEs, the network may signal the trained global policy to the UEs for deployment.

Further, although the above examples illustrate the RL model being used to select an anchor for a single UE, the above techniques may instead be performed for selecting at least one anchor in respect of a plurality of UEs. The selection of a positioning anchor or anchors may be performed for a group/plurality of UEs having similar mobility (such as, for example, platooning UEs and/or a pedestrian group). In this case, the signaling of the actions/selected anchor(s) from one entity to the group of UEs may be broadcast to the group of UEs or unicast to each UE in the group. The group of UEs may exchange information in relation to the RL model via sidelink signaling. For example, a single UE in the group may determine the selected anchor(s) for the group of UEs (via, for example, receiving the selected anchors from a network entity and/or by deploying the RL model), and forward identifier(s) of the selected anchor(s) to the remaining UEs in the group of UEs.

It is also understood that the above-references to an LMF may refer to an LMF that is located in a core part of a network, and/or to an LMF that is located in a radio access network (RAN).

Further, when a first entity (e.g., the target UE) obtains contradictory estimations when using the measurements from the selected anchors (for example, when the selected anchor reduces the positioning accuracy instead of improving it), that entity may report the contradiction to another entity (e.g., LMF) in order to request anchor reselection, to re-train the RL agent, and/or to initiate a malicious anchor check.

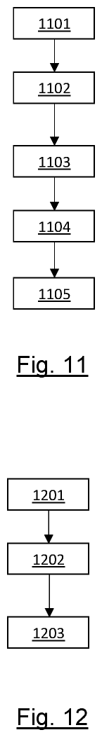

FIGS. 11 and 12 illustrate aspects of the above examples. It is therefore understood that features described above may be implemented in the presently described aspects in some example architectures and implementations.

FIG. 11 illustrates features that may be performed by a reinforcement learning agent located at a first apparatus. The first equipment may be a user equipment. The first equipment may be a network function (such as, for example, an LMF), which may be implemented in a core network entity and/or in a radio access network entity.

During 1101, the first apparatus receives, from a second apparatus, a request to select and/or deselect an anchor for determining a location of the first and/or second apparatus, the request comprising an indication of at least one potential anchor. The second apparatus may be as described below in relation to FIG. 12.

During 1102, the first apparatus requests, from a radio access network apparatus and/or the second apparatus, and/or the at least one potential anchor, first information related to at least one of: a resource availability of the at least one potential anchor, an energy state of the at least one potential anchor, or an indication of whether the at least one potential anchor is synchronised to a network.

During 1103, the first apparatus receives the requested first information;

During 1104, the first apparatus evaluates selecting and/or deselecting the anchor using the requested information.

During 1105, the first apparatus signals the evaluation to the second apparatus. This may comprise signalling at least one metric that represents a conclusion of the evaluation. Example forms for the at least one metric are discussed below.

Evaluating the anchor using the requested information may comprise: constructing a state representation of an environment surrounding the apparatus whose location is to be determined; inputting the state representation into a reinforcement learning model configured to output an evaluation of whether the anchor is to be selected and/or deselected given a set of environmental parameters as an input; and outputting the evaluation.

The reinforcement learning model may be trained prior to said inputting, wherein training the reinforcement learning model may comprise at least one of: calculating a positioning accuracy and/or latency of a position determined using an anchor selected and/or deselected by the reinforcement learning model to form a first positioning accuracy and/or latency; or receiving, from the second apparatus, a second calculated positioning accuracy and/or latency of a position determined using an anchor selected and/or deselected by the reinforcement learning model.

The first apparatus may: use the first and/or second calculated positioning accuracy and/or latency to form a reward signal; input the reward signal into the reinforcement learning model; and determine whether to modify the reinforcement learning model in dependence on the reward signal.

The first apparatus may: receive, from a third apparatus, a third calculated positioning accuracy and/or latency of a position determined using an anchor selected by the reinforcement learning model; and use the third calculated positioning accuracy and/or latency to form the reward signal.

Evaluating the anchor may comprise evaluating a suitability of the at least one potential anchor for being selected and/or deselected.

The first apparatus may request, from a radio access network apparatus and/or the second apparatus, and/or the at least one potential anchor, second information related to at least one of: a velocity of the at least one potential anchor; or a coarse displacement from the first apparatus to the at least one potential anchor; or a confidence level associated with a positioning of the at least one potential anchor; or an indication of at least one positioning capability of the at least one potential anchor; and use said second information when selecting or deselecting the anchor.

The first apparatus may request, from a radio access network apparatus and/or the second apparatus, and/or the at least one potential anchor, third information related to at least one of: an indication of a type of anchor of the at least one potential anchor; a channel impulse response associated with a channel of the at least one potential anchor that is used for performing positioning-related measurements; an indication of whether a channel of the at least one potential anchor that is used for performing positioning-related measurements is line-of-sight; an indication of, at the apparatus whose location is to be determined, a received power of at least one signal transmitted by the at least one potential anchor; an indication of, at the apparatus whose location is to be determined, an interference level of at least one signal transmitted by the at least one potential anchor; or an indication of a velocity of the apparatus whose location is to be determined; and use said second information when selecting the anchor.

Evaluating the anchor may comprise evaluating the anchor for the second apparatus and a third apparatus.

The evaluation may comprise at least one of: a probability distribution to be used for selecting and/or deselecting the anchor for use when performing positioning measurements; that the evaluated anchor is to be selected; that the evaluated anchor is to be deselected; a weight, priority, or rank to be used for selecting and/or deselecting the anchor for use when performing positioning measurements. In other words, the evaluation may provide an indication of whether a particular anchor should be selected or deselected for use when providing positioning measurements for determining a location of another device.

FIG. 12 illustrates operations that may be performed by a second apparatus. The second apparatus of FIG. 12 may correspond to the second apparatus of FIG. 11. The second equipment may be a user equipment. The second equipment may be a network function (such as, for example, an LMF), which may be implemented in a core network entity and/or in a radio access network entity.

During 1201, the second apparatus signals, to a first apparatus comprising a reinforcement learning agent, a request to select or deselect an anchor for determining a location of the first and/or second apparatus, the request comprising an indication of at least one potential anchor. The first apparatus may be as described above in relation to FIG. 11.

During 1202, the second apparatus may receive, from the first apparatus, a request for information related to at least one of: a resource availability of the at least one potential anchor, an energy state of the at least one potential anchor, or an indication of whether the at least one potential anchor is synchronised to a network.

During 1203, the second apparatus may provide the requested information to the first apparatus.

The second apparatus may receive, from the first apparatus, a request for second information related to at least one of: a velocity of the at least one potential anchor; a coarse displacement from the first apparatus to the at least one potential anchor; a confidence level associated with a positioning of the at least one potential anchor; or an indication of at least one positioning capability of the at least one potential anchor; and signal said second information to the first apparatus.

The apparatus may receive, from the first apparatus, a request for third information related to at least one of: an indication of a type of anchor of the at least one potential anchor; a channel impulse response associated with a channel of the at least one potential anchor that is used for performing positioning-related measurements; an indication of whether a channel of the at least one potential anchor that is used for performing positioning-related measurements is line-of-sight; an indication of, at the apparatus whose location is to be determined, a received power of at least one signal transmitted by the at least one potential anchor; an indication of, at the apparatus whose location is to be determined, an interference level of at least one signal transmitted by the at least one potential anchor; or an indication of a velocity of the apparatus whose location is to be determined; and signal said third information to the first apparatus.

The second apparatus may receive, from the first apparatus, an evaluation of the anchor for use in determining whether to use the anchor for performing positioning measurements, wherein the evaluation comprises at least one of: a probability distribution to be used for selecting and/or deselecting the anchor for use when performing positioning measurements; that the evaluated anchor is to be selected; that the evaluated anchor is to be deselected; a weight, priority, or rank to be used for selecting and/or deselecting the anchor for use when performing positioning measurements.

In all of the above examples of FIGS. 11 and 12, the first apparatus may be a user equipment, and the second apparatus is a location management function.

Further, in all of the above examples of FIGS. 11 and 12, the first apparatus may be a location management function, and the second apparatus may be a user equipment.

Further, in all of the above examples of FIGS. 11 and 12, the first apparatus may be a first user equipment and the second apparatus may be a second user equipment.

Further, in all of the above examples of FIGS. 11 and 12, there may be signalling, from the first apparatus to the second apparatus, an indication that at least one of said potential anchors of the received message is the selected or deselected anchor.

Further, in all of the above examples of FIGS. 11 and 12, there may be signalling, from the first apparatus to the second apparatus, an indication that at least one of said potential anchors of the received message is not the selected or deselected anchor.

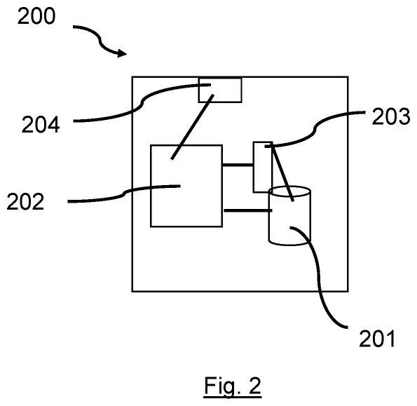

FIG. 2 shows an example of a control apparatus for a communication system, for example to be coupled to and/or for controlling a station of an access system, such as a RAN node, e.g. a base station, gNB, a central unit of a cloud architecture or a node of a core network such as an MME or S-GW, a scheduling entity such as a spectrum management entity, or a server or host, for example an apparatus hosting an NRF, NWDAF, AMF, SMF, UDM/UDR, and so forth. The control apparatus may be integrated with or external to a node or module of a core network or RAN. In some examples, base stations comprise a separate control apparatus unit or module. In other examples, the control apparatus can be another network element, such as a radio network controller or a spectrum controller. The control apparatus 200 can be arranged to provide control on communications in the service area of the system. The apparatus 200 comprises at least one memory 201, at least one data processing unit 202, 203 and an input/output interface 204. Via the interface the control apparatus can be coupled to a receiver and a transmitter of the apparatus. The receiver and/or the transmitter may be implemented as a radio front end or a remote radio head. For example, the control apparatus 200 or processor 201 can be configured to execute an appropriate software code to provide the control functions.

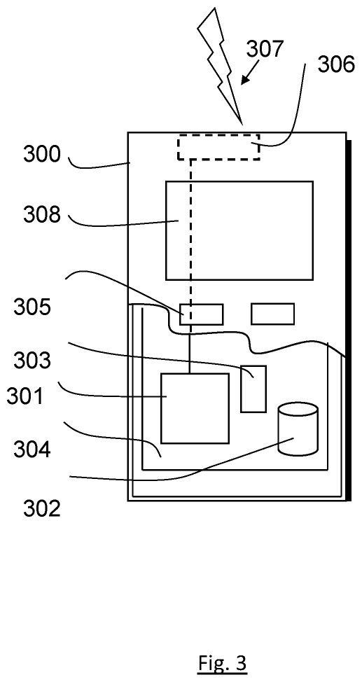

A possible wireless communication device will now be described in more detail with reference to FIG. 3 showing a schematic, partially sectioned view of a communication device 300. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is referred to as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

A wireless communication device may be for example a mobile device, that is, a device not fixed to a particular location, or it may be a stationary device. The wireless device may need human interaction for communication, or may not need human interaction for communication. As described herein, the terms UE or “user” are used to refer to any type of wireless communication device.

The wireless device 300 may receive signals over an air or radio interface 307 via appropriate apparatus for receiving and may transmit signals via appropriate apparatus for transmitting radio signals. In FIG. 3, a transceiver apparatus is designated schematically by block 306. The transceiver apparatus 306 may be provided, for example, by means of a radio part and associated antenna arrangement. The antenna arrangement may be arranged internally or externally to the wireless device.

A wireless device is typically provided with at least one data processing entity 301, at least one memory 302 and other possible components 303 for use in software and hardware aided execution of Tasks it is designed to perform, including control of access to and communications with access systems and other communication devices. The data processing, storage and other relevant control apparatus can be provided on an appropriate circuit board and/or in chipsets. This feature is denoted by reference 304. The user may control the operation of the wireless device by means of a suitable user interface such as keypad 305, voice commands, touch sensitive screen or pad, combinations thereof or the like. A display 308, a speaker and a microphone can be also provided. Furthermore, a wireless communication device may comprise appropriate connectors (either wired or wireless) to other devices and/or for connecting external accessories, for example hands-free equipment, thereto.

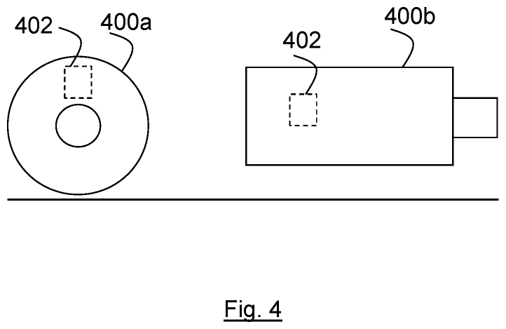

FIG. 4 shows a schematic representation of non-volatile memory media 400a (e.g. computer disc (CD) or digital versatile disc (DVD)) and 400b (e.g. universal serial bus (USB) memory stick) storing instructions and/or parameters 402 which when executed by a processor allow the processor to perform one or more of the steps of the methods of FIG. 11 and/or FIG. 12, and/or methods otherwise described previously.

As provided herein, various aspects are described in the detailed description of examples and in the claims. In general, some examples may be implemented in hardware or special purpose circuits, software, logic or any combination thereof. For example, some aspects may be implemented in hardware, while other aspects may be implemented in firmware or software which may be executed by a controller, microprocessor or other computing device, although examples are not limited thereto. While various examples may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The examples may be implemented by computer software stored in a memory and executable by at least one data processor of the involved entities or by hardware, or by a combination of software and hardware. Further in this regard it should be noted that any procedures, e.g., as in FIG. 11 and/or FIG. 12, and/or otherwise described previously, may represent program steps, or interconnected logic circuits, blocks and functions, or a combination of program steps and logic circuits, blocks and functions. The software may be stored on such physical media as memory chips, or memory blocks implemented within the processor, magnetic media (such as hard disk or floppy disks), and optical media (such as for example DVD and the data variants thereof, CD, and so forth).

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (AStudy ItemC), gate level circuits and processors based on multicore processor architecture, as nonlimiting examples.

Additionally or alternatively, some examples may be implemented using circuitry. The circuitry may be configured to perform one or more of the functions and/or method steps previously described. That circuitry may be provided in the base station and/or in the communications device and/or in a core network entity.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

The foregoing description has provided by way of non-limiting examples a full and informative description of some examples. However, various modifications and adaptations may become apparent to those skilled in the relevant arts in view of the foregoing description, when read in conjunction with the accompanying drawings and the claims. However, all such and similar modifications of the teachings will still fall within the scope of the claims.

In the above, different examples are described using, as an example of an access architecture to which the described techniques may be applied, a radio access architecture based on long term evolution advanced (LTE Advanced, LTE-A) or new radio (NR, 5G), without restricting the examples to such an architecture, however. The examples may also be applied to other kinds of communications networks having suitable means by adjusting parameters and procedures appropriately. Some examples of other options for suitable systems are the universal mobile telecommunications system (UMTS) radio access network (UTRAN), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

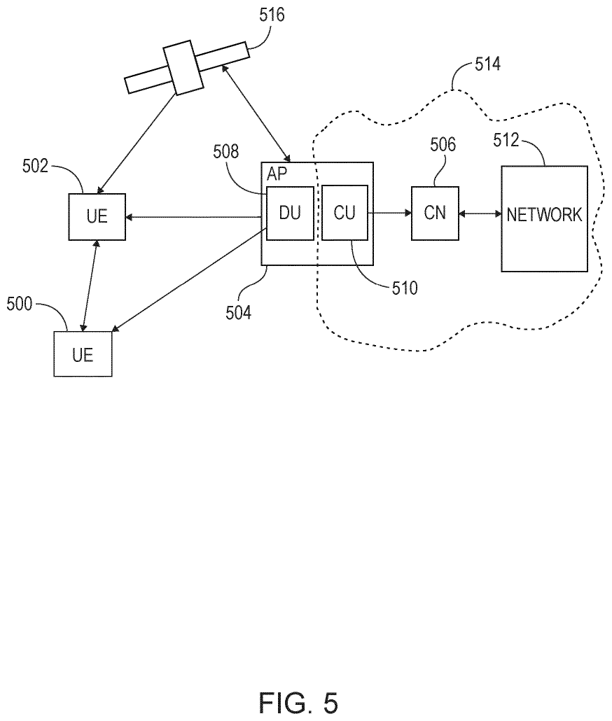

FIG. 5 depicts examples of simplified system architectures only showing some elements and functional entities, all being logical units, whose implementation may differ from what is shown. The connections shown in FIG. 5 are logical connections; the actual physical connections may be different. It is apparent to a person skilled in the art that the system typically comprises also other functions and structures than those shown in FIG. 5.

The examples are not, however, restricted to the system given as an example but a person skilled in the art may apply the solution to other communication systems provided with necessary properties.

The example of FIG. 5 shows a part of an exemplifying radio access network. For example, the radio access network may support sidelink communications described below in more detail.

FIG. 5 shows devices 500 and 502. The devices 500 and 502 are configured to be in a wireless connection on one or more communication channels with a node 504. The node 504 is further connected to a core network 506. In one example, the node 504 may be an access node such as (e/g) NodeB serving devices in a cell. In one example, the node 504 may be a non-3GPP access node. The physical link from a device to a (e/g) NodeB is called uplink or reverse link and the physical link from the (e/g) NodeB to the device is called downlink or forward link. It should be appreciated that (e/g) NodeBs or their functionalities may be implemented by using any node, host, server or access point etc. entity suitable for such a usage.

A communications system typically comprises more than one (e/g) NodeB in which case the (e/g) NodeBs may also be configured to communicate with one another over links, wired or wireless, designed for the purpose. These links may be used for signalling purposes. The (e/g) NodeB is a computing device configured to control the radio resources of communication system it is coupled to. The NodeB may also be referred to as a base station, an access point or any other type of interfacing device including a relay station capable of operating in a wireless environment. The (e/g) NodeB includes or is coupled to transceivers. From the transceivers of the (e/g) NodeB, a connection is provided to an antenna unit that establishes bi-directional radio links to devices. The antenna unit may comprise a plurality of antennas or antenna elements. The (e/g) NodeB is further connected to the core network 506 (CN or next generation core NGC). Depending on the deployed technology, the (e/g) NodeB is connected to a serving and packet data network gateway (S-GW+P-GW) or user plane function (UPF), for routing and forwarding user data packets and for providing connectivity of devices to one or more external packet data networks, and to a mobile management entity (MME) or access mobility management function (AMF), for controlling access and mobility of the devices.

Examples of a device are a subscriber unit, a user device, a user equipment (UE), a user terminal, a terminal device, a mobile station, a mobile device, etc

The device typically refers to a mobile or static device (e.g. a portable or non-portable computing device) that includes wireless mobile communication devices operating with or without an universal subscriber identification module (USIM), including, but not limited to, the following types of devices: mobile phone, smartphone, personal digital assistant (PDA), handset, device using a wireless modem (alarm or measurement device, etc.), laptop and/or touch screen computer, tablet, game console, notebook, and multimedia device. It should be appreciated that a device may also be a nearly exclusive uplink only device, of which an example is a camera or video camera loading images or video clips to a network. A device may also be a device having capability to operate in Internet of Things (IoT) network which is a scenario in which objects are provided with the ability to transfer data over a network without requiring human-to-human or human-to-computer interaction, e.g. to be used in smart power grids and connected vehicles. The device may also utilise cloud. In some applications, a device may comprise a user portable device with radio parts (such as a watch, earphones or eyeglasses) and the computation is carried out in the cloud.

The device illustrates one type of an apparatus to which resources on the air interface are allocated and assigned, and thus any feature described herein with a device may be implemented with a corresponding apparatus, such as a relay node. An example of such a relay node is a layer 3 relay (self-backhauling relay) towards the base station. The device (or, in some examples, a layer 3 relay node) is configured to perform one or more of user equipment functionalities.

Various techniques described herein may also be applied to a cyber-physical system (CPS) (a system of collaborating computational elements controlling physical entities). CPS may enable the implementation and exploitation of massive amounts of interconnected information and communications technology, ICT, devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 5) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control). 5G is expected to have multiple radio interfaces, e.g. below 6 GHz or above 24 GHz, cmWave and mmWave, and also being integrable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHZ-cmWave, 6 or above 24 GHZ-cmWave and mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The LTE network architecture is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks 512, such as a public switched telephone network, or a VoIP network, or the Internet, or a private network, or utilize services provided by them. The communication network may also be able to support the usage of cloud services, for example at least part of core network operations may be carried out as a cloud service (this is depicted in FIG. 5 by “cloud” 514). This may also be referred to as Edge computing when performed away from the core network. The communication system may also comprise a central control entity, or a like, providing facilities for networks of different operators to cooperate for example in spectrum sharing.

The technology of Edge computing may be brought into a radio access network (RAN) by utilizing network function virtualization (NFV) and software defined networking (SDN). Using the technology of edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at or close to a remote antenna site (in a distributed unit, DU 508) and non-real time functions being carried out in a centralized manner (in a centralized unit, CU 510).

It should also be understood that the distribution of labour between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where Edge computing servers can be placed between the core and the base station or nodeB (gNB). One example of Edge computing is MEC, which is defined by the European Telecommunications Standards Institute. It should be appreciated that MEC (and other Edge computing protocols) can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, Mobile Broadband, (MBB) or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano) satellites are deployed). Each satellite in the mega-constellation may cover several satellite-enabled network entities that create on-ground cells. The on-ground cells may be created through an on-ground relay node or by a gNB located on-ground or in a satellite.

The depicted system is only an example of a part of a radio access system and in practice, the system may comprise a plurality of (e/g) NodeBs, the device may have an access to a plurality of radio cells and the system may comprise also other apparatuses, such as physical layer relay nodes or other network elements, etc. At least one of the (e/g) NodeBs or may be a Home (e/g) nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g) NodeBs of FIG. 5 may provide any kind of these cells. A cellular radio system may be implemented as a multilayer network including several kinds of cells.

1) A method for a reinforcement learning agent located at a first apparatus, the method comprising:
receiving, from a second apparatus, a request to select and/or deselect an anchor for determining a location of the first and/or second apparatus, the request comprising an indication of at least one potential anchor;
requesting, from a radio access network apparatus and/or the second apparatus, and/or the at least one potential anchor, first information related to at least one of: a resource availability of the at least one potential anchor, an energy state of the at least one potential anchor, or an indication of whether the at least one potential anchor is synchronised to a network;
receiving the requested first information;
evaluating selecting and/or deselecting the anchor using the requested information; and
signalling the evaluation to the second apparatus.

2) The method as claimed in claim 1, wherein evaluating the anchor using the requested information comprises:
constructing a state representation of an environment surrounding the apparatus whose location is to be determined;
inputting the state representation into a reinforcement learning model configured to output an evaluation of whether the anchor is to be selected and/or deselected given a set of environmental parameters as an input; and
outputting the evaluation.

3) The method as claimed in claim 2, wherein the reinforcement learning model is trained prior to said inputting, wherein training the reinforcement learning model comprises at least one of:
calculating a positioning accuracy and/or latency of a position determined using an anchor selected and/or deselected by the reinforcement learning model to form a first positioning accuracy and/or latency; or
receiving, from the second apparatus, a second calculated positioning accuracy and/or latency of a position determined using an anchor selected and/or deselected by the reinforcement learning model.

4) The method as claimed in claim 3, comprising:
using the first and/or second calculated positioning accuracy and/or latency to form a reward signal;
inputting the reward signal into the reinforcement learning model; and
determining whether to modify the reinforcement learning model in dependence on the reward signal.

5) The method as claimed in claim 4, comprising:
receiving, from a third apparatus, a third calculated positioning accuracy and/or latency of a position determined using an anchor selected by the reinforcement learning model; and
using the third calculated positioning accuracy and/or latency to form the reward signal.

6) The method as claimed in claim 1, wherein evaluating the anchor comprises evaluating a suitability of the at least one potential anchor for being selected and/or deselected.

7) The method as claimed in claim 1, comprising:
requesting, from a radio access network apparatus and/or the second apparatus, and/or the at least one potential anchor, second information related to at least one of:
a velocity of the at least one potential anchor;
a coarse displacement from the first apparatus to the at least one potential anchor;
a confidence level associated with a positioning of the at least one potential anchor; or
an indication of at least one positioning capability of the at least one potential anchor; and
using said second information when selecting or deselecting the anchor.

8) The method as claimed in claim 1, comprising:
requesting, from a radio access network apparatus and/or the second apparatus, and/or the at least one potential anchor, third information related to at least one of:
an indication of a type of anchor of the at least one potential anchor;
a channel impulse response associated with a channel of the at least one potential anchor that is used for performing positioning-related measurements;
an indication of whether a channel of the at least one potential anchor that is used for performing positioning-related measurements is line-of-sight;
an indication of, at the apparatus whose location is to be determined, a received power of at least one signal transmitted by the at least one potential anchor;
an indication of, at the apparatus whose location is to be determined, an interference level of at least one signal transmitted by the at least one potential anchor; or
an indication of a velocity of the apparatus whose location is to be determined; and
using said second information when selecting the anchor.

9) The method as claimed in claim 1, wherein evaluating the anchor comprises evaluating the anchor for the second apparatus and a third apparatus.

10) The method as claimed in claim 1, wherein the evaluation comprises at least one of: a probability distribution to be used for selecting and/or deselecting the anchor for use when performing positioning measurements; that the evaluated anchor is to be selected; that the evaluated anchor is to be deselected; a weight, priority, or rank to be used for selecting and/or deselecting the anchor for use when performing positioning measurements.

11) A method for a second apparatus, the method comprising:
signalling, to a first apparatus comprising a reinforcement learning agent, a request to select or deselect an anchor for determining a location of the first and/or second apparatus, the request comprising an indication of at least one potential anchor;
receiving, from the first apparatus, a request for information related to at least one of: a resource availability of the at least one potential anchor, an energy state of the at least one potential anchor, or an indication of whether the at least one potential anchor is synchronised to a network; and
providing the requested information to the first apparatus.

12) The method as claimed in claim 11, comprising:
receiving, from the first apparatus, a request for second information related to at least one of:
a velocity of the at least one potential anchor;
a coarse displacement from the first apparatus to the at least one potential anchor;
a confidence level associated with a positioning of the at least one potential anchor; or
an indication of at least one positioning capability of the at least one potential anchor; and
signalling said second information to the first apparatus.

13) The method as claimed in claim 11, comprising:
receiving, from the first apparatus, a request for third information related to at least one of:
an indication of a type of anchor of the at least one potential anchor;
a channel impulse response associated with a channel of the at least one potential anchor that is used for performing positioning-related measurements;
an indication of whether a channel of the at least one potential anchor that is used for performing positioning-related measurements is line-of-sight;
an indication of, at the apparatus whose location is to be determined, a received power of at least one signal transmitted by the at least one potential anchor;
an indication of, at the apparatus whose location is to be determined, an interference level of at least one signal transmitted by the at least one potential anchor; or
an indication of a velocity of the apparatus whose location is to be determined; and
signalling said third information to the first apparatus.

14) The method as claimed in claim 11, comprising receiving, from the first apparatus, an evaluation of the anchor for use in determining whether to use the anchor for performing positioning measurements, wherein the evaluation comprises at least one of: a probability distribution to be used for selecting and/or deselecting the anchor for use when performing positioning measurements; that the evaluated anchor is to be selected; that the evaluated anchor is to be deselected; a weight, priority, or rank to be used for selecting and/or deselecting the anchor for use when performing positioning measurements.

15) The method as claimed in claim 1, wherein the first apparatus comprises a user equipment, and the second apparatus comprises a location management function.

16) The method as claimed in claim 1, wherein the first apparatus comprises a location management function, and the second apparatus comprises a user equipment.

17) The method as claimed in claim 1, wherein the first apparatus is a first user equipment and the second apparatus is a second user equipment.

18) The method as claimed in claim 15, comprising signalling, from the first apparatus to the second apparatus, an indication that at least one of said potential anchors of the received message is the selected or deselected anchor.

19) The method as claimed in claim 15, comprising signalling, from the first apparatus to the second apparatus, an indication that at least one of said potential anchors of the received message is not the selected or deselected anchor.

20)-23) (canceled)

24) A first apparatus, comprising:
at least one processor; and
at least one memory storing instructions that, when executed by the at least one processor, cause the first apparatus to perform at least:
receiving, from a second apparatus, a request to select and/or deselect an anchor for determining a location of the first and/or second apparatus, the request comprising an indication of at least one potential anchor;
requesting, from a radio access network apparatus and/or the second apparatus, and/or the at least one potential anchor, first information related to at least one of: a resource availability of the at least one potential anchor, an energy state of the at least one potential anchor, or an indication of whether the at least one potential anchor is synchronised to a network;
receiving the requested first information;
evaluating selecting and/or deselecting the anchor using the requested information; and
signalling the evaluation to the second apparatus.
